(19) United States
(12) Patent Application Publication
(10) Pub. No.: US 2025/0214178 A1
(43) Pub. Date: Jul. 3, 2025

(54) PUNCH-LASER COMBINATION METHOD AND PUNCH-LASER COMBINATION MACHINE FOR MACHINING A WORKPIECE, COMPUTER PROGRAM, AND COMPUTER-READABLE STORAGE MEDIUM

(71) Applicant: TRUMPF Werkzeugmaschinen SE + Co. KG, Ditzingen (DE)

(72) Inventors: Patrick Mach, Korb (DE); Takeshi Abiko, Ditzingen (DE)

(21) Appl. No.: 19/082,227

(22) Filed: Mar. 18, 2025

Related U.S. Application Data
(63) Continuation of application No. PCT/EP2023/075513, filed on Sep. 15, 2023.

(30) Foreign Application Priority Data
Sep. 21, 2022 (DE) 10 2022 124 202.1

(51) Int. Cl. B23K 26/38; B23K 26/00

(52) U.S. Cl. CPC B23K 26/38; B23K 26/0093

(57) ABSTRACT

A method for machining a workpiece includes providing a laser beam head. The laser beam head is capable of being switched between a cutting mode and a melting mode. In the cutting mode, a laser beam for material cutting with a material cutting linear energy is guided over a workpiece surface of the workpiece facing the laser beam head. In the melting mode, the laser beam for material melting with a material melting linear energy is guided over the workpiece surface. The method further includes forming an end hole which passes through the workpiece using the laser beam in a punching process, specifying a depression-producing line associated with the end hole, and forming a depression which opens into the end hole using the laser beam in a depression-producing laser process along the depression-producing line. The laser beam head is operated in the melting mode in the depression-producing laser process.

### CROSS REFERENCE TO RELATED APPLICATIONS

This application is a continuation of International Application No. PCT/EP2023/075513 (WO 2024/061775 A1), filed on Sep. 15, 2023, and claims benefit to German Patent Application No. DE 10 2022 124 202.1, filed on Sep. 21, 2022. The aforementioned applications are hereby incorporated by reference herein.

### FIELD

Embodiments of the present invention relate to a punch-laser combination method for machining a workpiece-in particular a metallic and plate-shaped workpiece. Embodiments of the present invention further relate to a computer program for a control device designed for electronic data processing for the punch-laser combination machine and to a computer-readable storage medium on which the computer program is stored.

### BACKGROUND

It is known according to the prior art to cut a hole in a plate-like workpiece by means of laser cutting. Depending on the intended use of the hole, extensive reworking of the hole may be/become necessary. If, for example, a head part of a countersunk head screw is to be arranged in the hole, a depression acting as a countersunk head receiver must be formed on one edge of the hole-usually by means of machining, for example using a countersink or the like. In addition, a burr formed on the edge of the hole and/or hardened slag splashes must be removed from the workpiece surface for safety and/or quality reasons. Such and similar rework processes that follow the hole cutting are particularly time-consuming; a lot of manpower is required and production time, in particular cycle time, can often be undesirably long.

A laser embossing composite system is known from JP 2021 142 532 A, in which a recess is embossed into the workpiece by means of an embossing die, which dips into the workpiece but does not pass through it. The recess can have a chamfer. A laser beam is then used to cut a hole that passes through the workpiece from the bottom of the recess to a workpiece surface opposite the recess.

JP 2016 203 209 A proposes forming a frustoconical protrusion on a workpiece in the form of a thin plate by first punching a pilot hole passing through the plate. Multiple radial slits are then cut into the plate by means of laser machining, which extend away from the pilot hole in a radial pattern. Then a large number of trapezoidal surface moldings, which are separated from one another by the radial slits, are bent to one side of the plate, resulting in the frustoconical protrusion. However, this is not very stable.

### SUMMARY

Embodiments of the present invention provide a method for machining a workpiece. The method includes providing a laser beam head. The laser beam head is capable of being switched between a cutting mode and a melting mode. In the cutting mode, a laser beam for material cutting with a material cutting linear energy is guided over a workpiece surface of the workpiece facing the laser beam head. In the melting mode, the laser beam for material melting with a material melting linear energy is guided over the workpiece surface. The method further includes forming an end hole which passes through the workpiece using the laser beam in a punching process, specifying a depression-producing line associated with the end hole, and forming a depression which opens into the end hole using the laser beam in a depression-producing laser process along the depression-producing line. The laser beam head is operated in the melting mode in the depression-producing laser process.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a punch-laser combination machine designed to carry out a punch-laser combination method for machining a workpiece according to some embodiments;

FIG. 2a and FIG. 2b show a schematic view cut along a sectional plane A-A (FIG. 2a) and top view (FIG. 2b) of the workpiece, wherein an end hole is punched directly using a punching process, according to some embodiments;

FIG. 3a and FIG. 3b show a schematic view cut along the sectional plane A-A (FIG. 3a) and top view (FIG. 3b) of the workpiece, wherein a depression is produced at the end hole by means of a depression-producing laser process, according to some embodiments;

FIG. 4a and FIG. 4b show a schematic view cut along the sectional plane A-A (FIG. 4a) and top view (FIG. 4b) of the workpiece, wherein a pilot hole is produced by means of a pilot hole punching step of the punching process, according to some embodiments;

FIG. 5a and FIG. 5b show a schematic view cut along the sectional plane A-A (FIG. 5a) and top view (FIG. 5b) of the workpiece, wherein the depression is produced at the pilot hole by means of the depression-producing laser process, according to some embodiments;

FIG. 6 shows a schematic view cut along the sectional plane A-A of the workpiece, wherein the end hole is finally produced by means of an end hole punching step, which takes place after the pilot hole and the depression have been produced, according to some embodiments;

FIG. 7 shows a schematic view cut along the sectional plane A-A of the workpiece, wherein the end hole is finally produced by means of an end hole laser cutting process, which takes place after the pilot hole and the depression have been produced, according to some embodiments; and

FIG. 8 shows a schematic view cut along the sectional plane A-A of the workpiece, wherein the pilot hole is produced by means of a pilot hole laser cutting process, which takes place before the depression and the end hole are produced, according to some embodiments.

### DETAILED DESCRIPTION

Embodiments of the invention provide a punch-laser combination method for machining a workpiece. The method can simplify the production of a hole with a depression. The method can be used to produce a hole with a depression that passes through the workpiece. In addition, the invention relates to a punch-laser combination machine which is designed to carry out the punch-laser combination method. In other words, the punch-laser combination machine is designed to manufacture or produce the hole having the depression.

According to embodiments of the invention, a punch-laser combination method for machining a workpiece, in particular for producing a hole passing through the workpiece and having a depression, is provided. Embodiments of the invention also provide a punch-laser combination machine designed to carry out the method, i.e., to produce said hole. In this regard, the punch-laser combination machine has means for carrying out the method. In particular, it has a punching tool and a laser tool as well as a control device for controlling the tools. The control device is, in particular, an EDP control device, i.e., a control device that is designed for electronic data processing. Embodiments of the invention further relate to a computer program for a control device designed for electronic data processing, in particular for the control device of the punch-laser combination machine. The computer program comprises control commands which cause the control device, in particular the punch-laser combination machine having the control device, to carry out the steps of the method. Based on the execution or processing of the computer program or its control commands by means of the control device designed for electronic data processing, this control device provides output control commands which characterize the steps of the method, wherein the output control commands are accepted by the punch-laser combination machine, in particular its tools, as input control commands. Embodiments of the invention further relate to a computer-readable storage medium, i.e., a data carrier on which the computer program is stored.

The workpiece is in particular a plate-shaped workpiece. Furthermore, the workpiece is made of a metallic material. For machining, the workpiece, for example the metal plate, is placed in a machining region of the punch-laser combination machine. The workpiece can be secured in the machining region in a reversible, non-destructive, releasable, force-and/or form-fitting manner. A surface of the workpiece facing the tools of the punch-laser combination machine is referred to herein as the top side of the workpiece, whereas a surface of the workpiece facing away from the top side of the workpiece and spaced apart from it by a workpiece thickness is referred to as the bottom side of the workpiece. The top side of the workpiece to be machined using the punch-laser combination method or punch-laser combination machine is flat. A laser beam head of the laser tool can be moved parallel to the workpiece and perpendicular to the top side of the workpiece. In order to simplify the description, it is not mentioned here whether the workpiece is moved in relation to the laser beam or vice versa.

During operation of the punch-laser combination machine, the laser beam guided by the laser beam head emerges at a terminal laser beam nozzle of the laser beam head, in particular the laser tool, and is provided in the form of a laser beam cone that is rotationally symmetrical in relation to a central beam symmetry axis. A beam diameter characterizes a transverse expansion or a physical size of the laser beam perpendicular to the beam symmetry axis. The laser beam is bundled by means of a focusing lens or a focusing mirror. The focal point (which can also be referred to as the focus) of the laser beam is defined by the point with the smallest beam diameter.

The power of the laser beam describes the optical output power of a continuous wave laser or the average power of a pulsed laser. Energy density is the energy of the laser beam in relation to the irradiated region of the workpiece. The linear energy is a value that characterizes the laser beam power absorbed by the workpiece in relation to the advance rate of the laser machining head or laser beam. In laser machining, the linear energy of the laser beam is crucial, wherein the energy absorbed by the workpiece depends on the energy density. For a determined laser beam power, the energy absorbed by the workpiece depends on the size of the beam spot on the workpiece, i.e., the laser beam diameter at the point where the laser beam hits the workpiece.

The beam diameter on the workpiece, i.e., the beam spot diameter, results from the focus position, i.e., the vertical distance between the focal point and the laser-irradiated top side of the workpiece. If the workpiece is arranged in a divergent beam region of the laser beam cone, which means that the focal point is above the top side of the workpiece, the beam diameter becomes larger when the distance between the focal point and the top side of the workpiece is increased (defocusing) or smaller when the distance is reduced (focusing). By changing the focus position, the energy density of the laser beam and, as a result, the energy absorbed by the workpiece, which is included in the linear energy, can be changed in a targeted manner. The larger the beam diameter, the smaller the energy absorbed by the workpiece and vice versa. In addition, increasing the advance rate reduces the linear energy and vice versa. It is to be understood that the energy density and consequently the linear energy can be influenced by changing the power of the laser beam itself.

The laser beam head is further used to guide a process gas jet that flows out of the terminal laser beam nozzle or a separate process gas nozzle. In particular, the process gas jet is guided coaxially to the laser beam. The process gas jet emerging from the nozzle can be designed as a gas cone that impinges on the workpiece. In this context, the person skilled in the art is aware of ways of influencing the laser energy introduced into the workpiece, for example by changing the type and/or composition of the process gas used during laser machining. Helium, argon or nitrogen, for example, are used as inert process gases. Oxygen can be used as a reactive process gas. The use of gas mixtures or compressed air is also conceivable.

In the punch-laser combination method, a laser beam head designed to carry out a laser process of the method is switchable between a cutting mode and a melting mode. In particular, the laser beam head is part of the laser tool of the punch-laser combination machine. In cutting mode, a laser beam is guided by the laser beam head for material cutting with a material cutting linear energy over a workpiece surface of the workpiece facing the laser tool. On the other hand, in melting mode, the laser beam is guided over the workpiece surface with a material melting linear energy in order to melt the material. For example, in cutting mode, the laser beam is focused more strongly so that a cutting beam spot diameter is projected onto the workpiece surface that is smaller than a melting beam spot diameter associated with the melting mode. This can be done by optically focusing/defocusing using the focusing lens or the focusing mirror and/or by changing the distance between the laser beam head and the top side of the workpiece. Furthermore, the laser beam head can be moved at a lower advance rate in the cutting mode than in the melting mode. In addition, the type and/or composition of the process gas can be changed. In any case, the material cutting linear energy associated with the cutting mode is higher than the material melting linear energy associated with the melting mode.

In particular, the laser beam head is switched to melting or cutting mode simply by changing the focus position. In this regard, it may be possible to change the focus position without adjusting the optics, i.e., merely by changing the working distance. A laser beam nozzle mouth of the laser beam nozzle, from which the laser beam emerges, and the top side of the workpiece are spaced apart in the cutting mode by the working distance, which is less than 2 mm, for example. On the other hand, the working distance in melting mode (such as to produce the depression) is at least 30 mm, 20 in particular at least 40 mm and particularly preferably around 50 mm. This means that the laser beam is sufficiently defocused in the melting mode such that a sufficiently large beam spot is projected onto the top side of the workpiece. In addition, a low process gas pressure is created with high coverage of the machining zone. Furthermore, it is ensured that the laser beam nozzle mouth (and/or elements of the laser tool arranged in the region of the laser beam nozzle mouth, for example a protective glass, etc.) are not contaminated by splashing slag.

The cutting mode is a cutting operating mode of the laser beam head, wherein the linear energy of the laser beam is such that the laser beam machines the workpiece in a cutting (separating) manner, wherein the workpiece is penetrated. This creates a kerf that passes through the workpiece completely. The melting mode is a different, non-cutting operating mode of the laser beam head, wherein the linear energy of the laser beam is so low that the laser beam machines the workpiece in a non-cutting (non-separating) manner, wherein the workpiece is not penetrated. Accordingly, no kerf is created, but rather a recess, in particular the depression.

The method uses a punching process comprising one or more punching steps to form an end hole that passes through the workpiece. It is conceivable that the method has a laser process that is used to produce the end hole in addition to the punching process. It should also be understood that the production of the end hole only needs to have one punching step; further punching steps to produce the end hole are not excluded. The end hole is a material-free space that passes through the workpiece. One shape of the end hole is formed according to a straight prism, according to a straight cylinder or a mixed body with one or more prismatic and one or more cylindrical parts.

The method further encompasses that a depression-producing line associated with the end hole is specified. If not already done, the laser beam head is then switched to the melting mode in order to carry out a depression-producing laser process. In the depression-producing laser process, in which the laser beam head is operated in the melting mode, the laser beam is guided along the depression-producing line, forming the depression opening into the end hole. In particular, the laser beam is guided along the depression-producing line two or more times. Advantageously, the depression-producing line is traversed two to 25 times with the laser beam nozzle or laser beam in order to produce the depression. In particular, in order to produce the depression, i.e., in the melting mode, the process gas jet can have a gas pressure of less than 5 bar, in particular from 2 bar to 3.5 bar. Furthermore, it has proven to be advantageous if the advance rate of the laser beam head for producing the depression is at least 4 m/min and the power of the laser beam is at least 750 W up to 4000 W.

The end hole-producing line belonging to the end hole runs, for example, around an end hole edge delimiting the end hole or around an end hole-producing line along which the end hole is formed. Here, the depression-producing line encloses the end hole edge or end hole-producing line. The depression-producing line may also run around a pilot hole edge delimiting a pilot hole or around a pilot hole-producing line along which the pilot hole may be formed. In this regard, the depression-producing line encloses the pilot hole edge or pilot hole-producing line. Such a pilot hole is a preliminary stage that can, but does not have to, be formed prior to the final end hole being produced. After final production of the end hole, the inner circumferential surface of the end hole can be reworked or further processed. The pilot hole is described in more detail below. The end hole edge can be circular in shape. Other shapes of the end hole edge are also conceivable; for example, the end hole can be an elongated hole. The end hole edge can also be designed as an oval, a polygon or a combination of these.

The respective producing line is a purely technical process line that is not formed on the workpiece. The depression-producing line characterizes a guide path along which the laser beam head is moved during the production/for producing the depression. The depression-producing line is arranged such that the depression is produced adjacent to the hole in question, i.e., the pilot hole or end hole. In any case, the depression opens into the hole in question. Consequently, the depression deepens towards the corresponding hole and merges directly into that hole. The depression-producing line surrounds or encloses the corresponding hole-producing line or the corresponding hole edge. If the depression-producing line and the relevant hole-producing line or the relevant hole edge are viewed in a top view, the depression-producing line encloses said hole-producing line or hole edge, wherein the depression-producing line (in simplified terms) appears as an enlarged or scaled-up hole-producing line or hole edge. The depression-producing line and the hole-producing line or hole edge are spaced apart at a constant distance from one another along their respective curves. For example, the depression-producing line and the hole-producing line or hole edge are each circular lines (circular paths). In this regard, a diameter of the depression-producing line is larger than a diameter of the hole-producing line or hole edge. The depression-producing line and the hole-producing line or hole edge can coincide. The corresponding hole-producing line can also be a guide path for the laser beam head carrying out a laser process. Furthermore, the corresponding hole-producing line can be a punching field outline along which a punch of the punching tool strikes the top side of the workpiece. The respective producing line can be an open curve or a closed geometric figure, for example a circle.

The depression-producing laser process can be used to create or produce the depression at the final end hole. It is also conceivable that the depression is already produced using the depression-producing laser process when the end hole is not yet finally produced, i.e., only partially produced, for example. In particular, the depression-producing laser process can be carried out to produce the depression when the end hole is not yet completely free of material or is still partially covered with material. This is the case, for example, if the pilot hole has been produced but the end hole has not yet been produced. A countersunk hole is produced in the workpiece using this method or the punch-laser combination machine. The terms “pilot hole” and “end hole” are merely used to distinguish different phases of the method of producing the countersunk hole, wherein the end hole is formed by removing material from an inner circumferential surface of the pilot hole, thereby widening the pilot hole to form the end hole. The countersunk hole is produced by creating the end hole within the depression or by forming the depression at the end hole edge.

The combination of punching and laser cutting described herein makes it possible to produce a countersunk hole in a particularly efficient and/or low-cost manner. In particular, comparatively large depression diameters (at least up to M12) can be reliably implemented in conjunction with particularly strong workpieces or particularly strong/thick metal plates (thickness of 8 millimeters and more). A particular advantage is that the material of the workpiece, which melts when the depression is produced, is efficiently discharged as a liquid or at least as a pasty melt through the end hole (or, if applicable, through the pilot hole). In this regard, the melt can be propelled by the process gas jet and blown through the corresponding hole, so to speak; there is no need to clean the top side of the workpiece. In addition, any burr that may have been created during the production of the end hole (or possibly the pilot hole) is also removed due to the depression-producing laser process and is also removed from the workpiece through the corresponding hole. Productivity is significantly increased compared to pure laser machining, wherein the end hole is finally produced by means of the laser and then the depression is produced by means of the laser. In addition, heat input into the material, in particular into the metal or sheet metal, is reduced compared to pure laser machining.

In order to form the end hole, in another possible embodiment a pilot hole is formed which passes through the workpiece and is smaller than the end hole. In this regard, an end hole edge of the end hole and a pilot hole edge of the pilot hole are geometrically similar. According to this embodiment, the pilot hole is formed first to form the end hole and the end hole is formed later. In a mathematical-geometric sense, the end hole edge and the pilot hole edge are not congruent, i.e., not completely coincident, but similar. If the end hole-producing line and the pilot hole-producing line are viewed in a top view, the end hole-producing line encloses the pilot hole-producing line, wherein the end hole-producing line (in simplified terms) appears as an enlarged or scaled-up pilot hole-producing line, wherein the end hole-producing line and the pilot hole-producing line are spaced apart at a constant distance from one another along their respective curves. This applies analogously when looking at the end hole edge and the pilot hole edge. If the depression hole or countersunk hole, i.e., the combination of the end hole with the depression, is circular in cross-section, the pilot hole is designed in particular such that its pilot hole diameter is 0.5 mm to 2 mm, preferably approximately 1 mm, smaller than the end hole diameter of the end hole. This measure ensures that, by producing the end hole, the burr that has accumulated in the region of the pilot hole during the production of the depression is reliably and safely removed.

In the method, it is possible, for example, that after the pilot hole is formed and before the end hole is finally produced, the depression-producing laser process is carried out, whereby the depression is produced, specifically along the pilot hole edge or along the depression-producing line surrounding the pilot hole edge. After the depression has been created, the end hole is finally produced. Alternatively, in the method, it is possible that after the pilot hole is formed, the end hole is finally produced and then the depression-producing laser process is carried out, whereby the depression is produced, specifically along the end hole edge or along the depression-producing line surrounding the end hole edge.

The pilot hole or the end hole is punched, or both the end hole and the pilot hole are punched. Furthermore, the end hole can be laser-cut, wherein the pilot hole is then punched. Alternatively, the pilot hole can be laser-cut, wherein the end hole is then punched. This is because the punching process, which has one or more punching steps, is used in the method described herein to produce the end hole, which includes the production of the pilot hole. In order to produce the pilot hole, a part of the workpiece known as a slug is removed from the workpiece during punching or laser cutting. For example, the slug is cut out along the pilot hole-producing line, i.e., lasered out, or the slug is punched out along the pilot hole-producing line. Other manufacturing processes for producing the end hole after punching the pilot hole or for producing the pilot hole after which the end hole is punched are conceivable, such as drilling, honing, etc. The workpiece, which has the pilot hole and possibly the depression but not yet the end hole, is an intermediate product, wherein the end product has the end hole and the depression. The production of the pilot hole is part of the production of the end hole and therefore constitutes a preliminary stage of the final production of the end hole.

Melt or slag, which is produced during the production of the depression, i.e., as a waste product of the depression-producing laser process, can thus be expelled from the workpiece particularly efficiently by means of the process gas jet through the pilot hole. This advantageously prevents burrs from forming on the top side of the workpiece facing the laser beam nozzle. Such a burr would not only impair subsequent error-free use of the depression, but could also form an obstacle for the moving laser beam nozzle, which it could strike against. In addition, any slag adhering to the inner circumferential surface of the pilot hole is also removed when the end hole is finally produced. The end hole with the depression-i.e., the countersunk hole-is produced burr-free in this manner, without the need for a separate deburring process.

In a further possible embodiment of the method, the punching process for producing the end hole has a pilot hole punching step which is carried out before the depression-producing laser process, wherein the pilot hole is punched free in the pilot hole punching step. In order to finally produce the end hole, the pilot hole is punched according to this embodiment, then the depression is formed and only then is the end hole finally produced. By punching the pilot hole in the pilot hole punching step of the punching process, heat input into the workpiece during the production of the end hole is at least reduced or—if the end hole is also punched—avoided in an advantageous manner.

Alternatively, a possible further development of the method provides for the pilot hole to be cut free by means of a pilot hole laser cutting process which is carried out before the depression-producing laser process, wherein the laser beam head is operated in the cutting mode. Before the pilot hole laser cutting process, the laser beam head is switched to the cutting mode—if not already done—in order to carry out the pilot hole laser cutting process. In order to finally produce the end hole, the pilot hole is laser-cut according to this embodiment, then the depression is formed (for which the laser beam head is switched to the melting mode) and only then is the end hole finally produced. When cutting the pilot hole using the laser tool, the laser beam is guided along the pilot hole-producing line at least once, in particular two or more times. In this regard, a pilot hole slug is cut out of the workpiece, forming an endless or closed pilot hole kerf, which has the shape of a circular disc cylinder. By removing the pilot hole slug from the rest of the workpiece, the material-free space characterizing the pilot hole is produced.

In this context, a further possible embodiment of the method provides that the pilot hole slug to be cut out of the workpiece in order to produce the pilot hole is cut by means of a dividing laser process before the pilot hole is cut free, wherein in the dividing laser process the laser beam head is operated in the cutting mode. This measure ensures that the cut-out pilot hole slug or its parts reliably fall out of the workpiece under their own weight so that the pilot hole is free. In this way, the melt/slag that occurs during the production of the depression can be efficiently driven out of the workpiece. Before the dividing laser process, the laser head is switched to the cutting mode—if not already done—in order to carry out the dividing laser process.

In conjunction with the punched pilot hole, i.e., with the punching process encompassing the pilot hole punching step, and/or in conjunction with the laser-cut pilot hole, i.e., the pilot hole laser cutting process, a further possible embodiment provides that the punching process has an end hole punching step which is carried out after the depression-producing laser process, wherein in the end hole punching step the end hole is punched free. According to this embodiment, both the pilot hole and the end hole are punched by means of a respective punching step. Laser machining of one of the two holes is taken into special consideration, wherein the laser beam head is operated in the cutting mode, is not necessary, which provides the advantage of a particularly low heat input into the material of the workpiece.

In a possible further development, the method may comprise, in conjunction with the punched pilot hole, an end hole laser cutting process which is carried out after the depression-producing laser process. If not already done, the laser beam head is switched to the cutting mode in order to carry out the end hole laser cutting process. The end hole is cut free by means of the end hole laser cutting process, wherein the laser beam head is operated in the cutting mode in the end hole laser cutting process. When cutting the end hole using the laser tool, the laser beam is guided along the end hole-producing line at least once, in particular two or more times. In this regard, an end hole slug is cut out of the workpiece, forming an endless or closed end hole cutting gap, which-since the pilot hole was previously formed-has the shape of a circular ring cylinder. By removing the end hole slug from the rest of the workpiece, the material-free space characterizing the end hole is produced, which is of a larger volume than the material-free space characterizing the pilot hole. The end hole-producing line is designed in particular in such a way that part of the depression is removed during the production of the end hole while the pilot hole and the depression are already present, wherein the depression is not completely removed here. Instead, part of the depression remains when the end hole is produced. As a result, the end hole edge facing the top side of the workpiece is arranged inside of the depression. With a circular depression and a circular end hole, the depression diameter is larger than the end hole diameter.

The depression-producing laser process and/or the pilot hole laser cutting process can be carried out using a continuous-wave laser (CW laser: continuous-wave laser), which provides a laser light wave of constant intensity. In contrast to this, the end hole laser cutting process can be carried out using a pulsed laser, which provides a pulsed laser light wave. This has the advantage that the material of the workpiece is not heated up as much when the end hole slug in the shape of a circular ring cylinder is cut out, which promotes the flowing off of the melt. The following operating parameters for operating the laser tool, in particular the laser beam head, have proven to be particularly advantageous for producing the end hole using the pulsed laser: average power: at least 200 W, peak pulse power: at least 2000 W, pulse frequency: between 10 Hz and 200 The method may also provide for the material melting linear energy of the laser beam to be changed during the production of the depression in order to specifically adjust a dimension of the depression, such as depth, etc., and/or the shape of the depression.

During the production of the depression, the pilot hole and/or the end hole, the laser beam is directed in particular perpendicular to the flat top side of the workpiece by means of the laser beam head, i.e., the angle between the beam symmetry axis and the top side of the workpiece is 90°. This has advantages in terms of control engineering. In addition, costs for the technical implementation of a corresponding pivoting capability of the laser beam relative to the plane of the workpiece support can be saved. It is also conceivable that the beam symmetry axis is changed when the workpiece is irradiated, wherein the beam symmetry axis at least temporarily adopts an angle other than 90° with respect to the top side of the workpiece. The alignment of the laser beam can be achieved by a pivoting device of the laser beam head and/or an optical pivoting device. For example, a larger area of the workpiece can be swept by pivoting the laser beam during the production of the depression.

According to a further possible embodiment, in the end hole laser cutting process, the laser beam nozzle mouth, from which the laser beam emerges, can be moved within the depression and below a plane which is defined by the workpiece surface facing the laser tool. In other words, the laser tool, in particular the laser beam nozzle mouth, can be partially dipped into the depression when producing/in order to produce the end hole. This allows the desired focus position for cutting/separating the material to be adjusted with a particularly high degree of accuracy for particularly large depressions. In addition, placing the laser beam nozzle so close to the pilot hole or to the part of the pilot hole that remains after the depression has been produced has the advantage that the end hole can be produced with a very precise geometry. Furthermore, the melt that occurs when the end hole is produced can be driven out of the workpiece particularly efficiently through the pilot hole.

The method may also provide for the pilot hole to be actively cooled before the depression is produced, in particular if it was produced by means of the laser. Alternatively or additionally, the depression can be actively cooled after it has been produced. Also alternatively or additionally, the end hole can be actively cooled, in particular if it was produced by means of the laser. Active cooling is achieved here by direct contact between the spot of the workpiece to be cooled and a cooling fluid flowing against or around that spot. For example, the process gas jet can be directed at the workpiece without the laser beam being switched on for this purpose. Active cooling can thus be switched between the individual production processes or individual production steps of the punch-laser combination method. For example, the spot of the workpiece to be cooled is subjected to an (initial) process gas pressure in the range of 2 bar to 20 bar. The expanding process gas cools the workpiece particularly efficiently according to the laws of thermodynamics. This measure can ensure that the metallic material of the pilot hole edge is hardened on the bottom side of the workpiece facing away from the laser beam nozzle so that the pilot hole edge is as sharp as desired. This further improves the flow of the melt that occurs during the final production of the end hole and/or during the production of the depression. In this respect, it is particularly advantageous if the active cooling of the pilot hole and the production of the end hole using the pulsed laser are combined, as both individual measures have the same advantageous effect. This synergy has a particularly strong effect when the laser beam nozzle is dipped into the depression during the production of the end hole.

Overall, the following variants of how the countersunk hole can be formed result for the punch-laser combination method, for example:

The end hole is punched directly using the punching process, i.e., without first forming the pilot hole, and the depression is then produced using the depression-producing laser process.

The pilot hole is punched using the pilot hole punching step of the punching process, after which the depression is produced using the depression-producing laser process. The end hole is then finally produced using the end hole punching step of the punching process.

The pilot hole is punched using the pilot hole punching step of the punching process, after which the depression is produced using the depression-producing laser process. The end hole is then finally produced using the end hole laser cutting process.

The pilot hole is laser-cut using the pilot hole laser cutting process, after which the depression is produced using the depression-producing laser process. The end hole is then finally produced using the end hole punching step of the punching process.

The laser beam, which is generated or emitted by means of the laser beam head for producing a depression, and the laser beam, which is generated or emitted by means of the laser beam head for cutting the end hole or pilot hole, have, in particular, different focus positions from one another. The focus position of the laser beam is adjusted in the cutting mode, i.e., for cutting the end hole or pilot hole so that the beam spot on the workpiece surface is smaller than when producing the depression. Consequently, the linear energy of the laser beam on the workpiece and thus the energy introduced into the workpiece when producing a depression is lower than when cutting the pilot hole or end hole. The focus position is adjusted, for example, by moving the laser beam head vertically perpendicular to the workpiece surface and changed so that a suitable material melting linear energy is provided in order to produce the depression or a suitable material cutting linear energy is provided in order to produce the pilot hole or end hole. In order to produce the pilot hole or end hole, the focus position is adjusted such that the focus or focal point is close to or inside the workpiece.

For example, the material melting linear energy used to produce the depression is less than 50%, less than 40%, less than 30%, less than 20%, less than 10% or less than 1% of the cutting linear energy used to cut the pilot hole or end hole. This difference between the linear energies is reflected in a change in the beam diameter on the workpiece surface, i.e., the respective beam spot diameter. For example, the cutting beam spot diameter on the workpiece surface used to cut the pilot or end hole is less than 50%, less than 40%, less than 30%, less than 20%, less than 10% or less than 1% of the melting beam diameter to produce the depression.

In general, the method may provide that the depression (i.e., the material-free space produced in the workpiece by the depression-producing laser process) is shaped according to a straight truncated cone having a circular top surface and a circular base surface. For example, the depression-producing line can be specified in a circular shape for this purpose, i.e., as a depression-producing circle-as another possible embodiment provides for. It can also be advantageous if a radius of the depression-producing circle is at least 0.5 mm, preferably at least 1 mm, in particular approx. 2 mm, larger than the pilot hole radius.

In an alternative embodiment to this, the depression-producing line is specified to be spiral-shaped, i.e., as a single-or multi-armed depression-producing spiral. In particular, the depression-producing spiral is designed such that the distance between the windings is constant. This can be, for example, 0.125 mm to 0.5 mm-an increase in winding diameter per complete 360° rotation of the laser beam head is therefore equal to 0.25 mm to 1 mm.

Depending on how large the depression diameter and/or a depression depth should be or what shape the depression should have, two or more depression-producing lines can be provided, which together then form a depression-producing line set. This is provided for in another possible embodiment, wherein the depression-producing line set is specified with two or more depression-producing lines. In this regard, the depression-producing lines of the depression-producing line set are geometrically similar to one another and share a common longitudinal axis. In the event that the depression-producing line set has two or more depression-producing circles, the depression-producing circles are arranged concentrically to one another. In particular, it is intended that the diameter of the respective depression-producing circles increases by 0.5 mm to 2 mm radially outwards. Advantageously, the radially innermost depression-producing circle has a radius in this regard that is 0.25 mm to 1 mm larger than the pilot hole radius. In the event that the depression-producing line set has two or more depression-producing spirals, the depression-producing spirals can have a common origin and be twisted with respect to one another.

If the depression is to be used to accommodate a countersunk head portion of a countersunk head screw, a radially outermost depression-producing circle can be provided with a diameter that is slightly smaller than a largest outer diameter of the countersunk head portion. Generally, a number of depression-producing lines and a number of times the laser beam head is guided along the depression-producing line(s) are determined based on the end hole diameter (approximately a nominal diameter of the countersunk head screw to be inserted) and the desired depression depth. For countersunk head screws with an M3 to M6 metric thread, at least two passes are required, wherein a typical number of passes is between two and 25. For countersunk head screws with an M8 to M12 metric thread, at least five passes are required, preferably at least ten, wherein a typical number of passes is between 10 and 25.

The method set forth herein can advantageously be used to produce many depression holes, for example a depression hole arrangement or series, in/on a workpiece. In this regard, the depression holes of the depression hole arrangement can be produced successively. It is also conceivable to first produce all the end holes of the depression hole arrangement directly and then form all of the depressions of the depression hole arrangement. It is also possible to first produce all pilot holes of the depression hole arrangement and then produce all depressions in order to finally produce all end holes of the depression hole arrangement.

The method can also be advantageously used to provide a cut-off edge with a chamfer. The cut-off edge is produced, for example, by separating a cut-off part from the original workpiece along an even or odd dividing line, for example by folding, cutting, sawing off, etc. The cut-off edge is then not a closed curve but forms a new contour of the workpiece freed from the cut-off part, at least partially. The chamfer can then be formed along the cut-off edge or a corresponding chamfer-producing line using the depression-producing laser process.

Further advantages, features and details of the embodiments of the invention are specified in the following description and the drawing. The features and combinations of features mentioned above in the description as well as the features and combinations of features shown below in the description of the figures and/or in the figures alone can be used not only in the combination indicated in each case, but also in other combinations or on their own.

Identical or functionally identical elements are designated with the same reference signs in the figures.

In the following, a punch-laser combination method and a punch-laser combination machine 1 for machining a workpiece 2 are set forth in a joint description. The steps of the method represent code components or control commands of a computer program which cause a control device 3, which in the present case is an EDP control device or a program-controlled control device of the punch-laser combination machine 1, to carry out the method. In other words, the computer program is a control program for the punch-laser combination machine 1. The program-controlled control device 3 is used to control the punch-laser combination machine 1, in particular its tools 4, 5, in an open or closed loop. This means that, as a result of the computer program being executed or processed by means of the control device 3, the latter provides output control commands which characterize the steps of the method so that the punch-laser combination machine 1 is controlled in accordance with the method steps or for executing the method steps in an open or closed loop. For example, the computer program is stored on a computer-readable storage medium (not shown).

The punch-laser combination machine 1 has a laser tool 4 and a punching tool 5, which are arranged so as to be movable together by means of an actuator (not shown) of the punch-laser combination machine 1 in a workspace 6 of the punch-laser combination machine 1 in such a way that the workpiece 2 stored in the workspace 6 can be machined by means of the tools 4, 5. For this purpose, the workpiece 2 is arranged, for example, on a workpiece support (not shown) of the punch-laser combination machine 1.

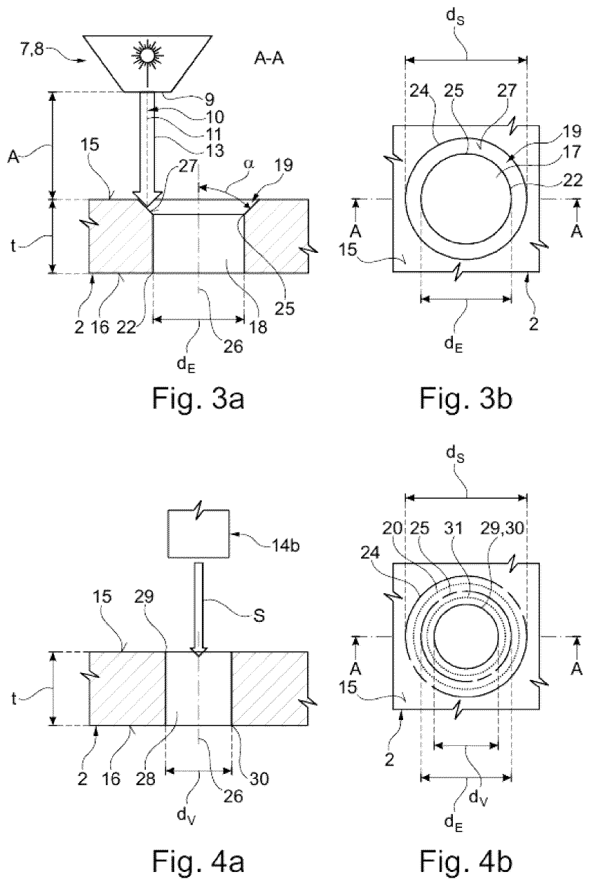

The laser tool 4 has a laser beam head 7 with a laser beam nozzle 8, from the laser beam nozzle mouth 9 of which a laser beam 10 (see, for example, FIG. 3a) emerges in a laser process of the method for laser machining of the workpiece 2. The laser beam head 7 can be moved along the spatial directions x, y and z by means of the actuator. The laser beam 10 is generated by means of a laser light source (not shown) and guided to the laser beam head 7 by means of a laser guidance device (not shown), which may, for example, have a beam guide tube, a deflection mirror, a laser light guide cable, etc. The laser beam head 7 also has laser optics, by means of which the laser beam 10 emerging from the laser beam nozzle mouth 9 is given the shape of a laser beam cone, which is rotationally symmetrical in relation to a beam symmetry axis 11 (see, for example, FIG. 3a). For example, the laser optics have at least one mirror and/or at least one lens for this purpose. At the point of the smallest beam diameter, the laser beam 10 or the laser beam cone has the focal point 12 (which can also be referred to as the focus 12). The laser optics can have an optics adjustment actuator unit (not shown) in order to be able to adjust a distance between the focal point and the laser beam nozzle mouth 9 as required-in particular during a machining operation. In the present case, the laser beam nozzle 8 is further designed to guide process gas supplied to the laser beam head 7 in such a way that it flows out of the laser beam nozzle mouth 9 as a process gas jet 13 (see, for example, FIG. 3a). In this regard, the process gas jet 13 is parallel, in particular coaxial, to the beam symmetry axis 11.

The punching tool 5 has a punch 14, which is designed to punch out a punching slug (not shown) from the workpiece 2 in a punching process of the method. The punch 14 can be moved along the spatial directions x, y and z by means of the actuator-in particular independently of the laser beam head 7. The punch-laser combination machine 1 is designed in such a way that the workpiece 2 is machined both by means of the laser tool 4 and by means of the punching tool 5 (for example, one after the other) without the workpiece 2 having to be repositioned or reclamped between a laser step and a punching step of the method in the punch-laser combination machine 1 or in its machining region. Furthermore, the tools 4, 5 are both coupled to the common control device 3 for data transmission. In the method, the workpiece 2 is moved, for example, underneath the two tools 4, 5, which can also be referred to as machining heads (laser cutting head, punching head), in the X and/or Y direction. In particular, the machining heads are stationary in this regard. It is also conceivable that the machining heads are designed to move along the X or Y direction and the metal sheet is moved in the corresponding other direction, i.e., along the Y or X direction.

In the present example, the workpiece 2 is a metal sheet or a metal plate and has a top side of the workpiece 15 and a bottom side of the workpiece 16. The workpiece sides 15, 16 are spaced apart by a workpiece thickness t. In the present case, the workpiece thickness t is more than 4 mm, in particular more than 8 mm. In the present case, the top side of the workpiece 15 is arranged in a divergent beam region of laser beam 10, which means that the focal point 12 is located above the top side of the workpiece 15.

By carrying out the punch-laser combination method using the punch-laser combination machine 1, a countersunk hole or depression hole 17 (shown for the first time in FIG. 3a/3b) is produced on/in the workpiece 2. For this purpose, a punching process of the method is used to form an end hole 18 (shown for the first time in FIG. 2a/2b) which passes through the workpiece 2 completely, i.e., which opens on the top side of the workpiece 15 on the one hand and on the bottom side of the workpiece 16 on the other. In addition, a depression 19 associated with the end hole 18 (shown for the first time in FIG. 3a/3b) is produced. Although the punch-laser combination method or the punch-laser combination machine I can be used to produce end holes 18 and depressions 19 of a wide variety of shapes, the method is explained below using a circular cylindrical cross-section of the end hole 18 (see sectional views A-A in the corresponding figures) or a frustoconical cross-section of the depression 19 (see sectional views A-A in the corresponding figures).

FIG. 2 shows a schematic view cut along a sectional plane A-A (FIG. 2a) and top view (FIG. 2b) of the workpiece 2, wherein the end hole 18 is punched directly using a punching process. For this purpose, a punch variant 14a of the punch 14 is used, which corresponds in shape and size, in particular with an end hole diameter d_{E}, to the end hole 18 to be formed. The punch 14 is moved towards the original workpiece 2, in particular towards its top side of the workpiece 15, specifically along a punching direction S. As the punch 14 is driven through the workpiece 2, an end hole punching slug in the shape of a circular disc cylinder (not shown) is driven out of the workpiece 2 so that a material-free space characterizing the end hole 18 passes through the workpiece 2. In FIG. 2a, the workpiece 2, which already has the end hole 18, is shown below the punch 14.

A depression-producing line 20 associated with the end hole 18 is then specified, along which the depression 19 is produced in a depression-producing laser process of the method. In this example, the depression-producing line 20 is circular. In order to carry out the depression-producing laser process, the laser beam head 7 is switched to a melting mode if the laser beam head 7 was switched to another operating mode or deactivated before the depression-producing laser process. In the depression-producing laser process, i.e., to produce the depression 19, the laser beam 10 is guided over the top side of the workpiece 15 for material melting with a material melting linear energy, specifically once or multiple times along the depression-producing line 20. Depending on the size of the depression 19, the depression-producing line 20 can be specified as a depression spiral, which is traversed in particular starting from its origin with the laser beam head 7 in order to produce the depression 19. Further, a depression-producing line set can be specified having two or more depression-producing lines 20, for example two or more concentric circles, two or more depression spirals, etc. The end hole 18 has a first end hole edge 21 and a second end hole edge 22. Via the first end hole edge 21, the end hole 18 opens at the top side of the workpiece 15, and via the second end hole edge 22, the end hole 18 opens at the bottom side of the workpiece 16. The depression-producing line 20 and the end hole edges 21, 22 are arranged in a concentric circle in the present case.

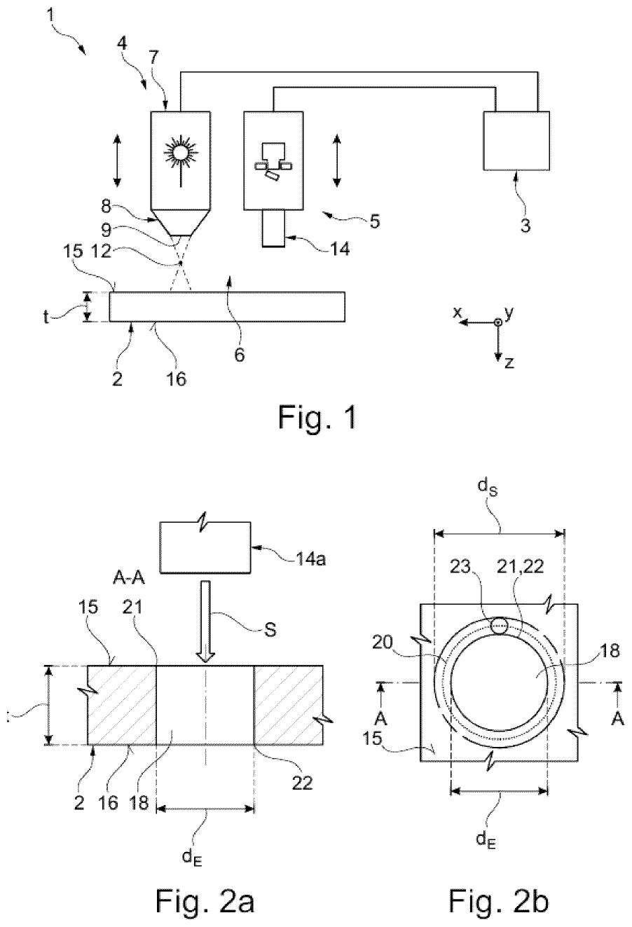

In this context, FIG. 3a shows a schematic view cut along the sectional plane A-A of the workpiece 2, wherein the depression 19 is produced at the end hole 18 by means of the depression-producing laser process. In order to switch or adjust the laser beam head 7 to the melting mode, it is in particular intended that the laser beam head 7 is moved vertically (or along the Z direction, see FIG. 1) in order to adjust a working distance, over which the laser beam nozzle mouth 9 and the top side of the workpiece 15 are spaced apart from one another, to a melting working distance A. Thus, a melting beam spot 23 (see FIG. 2b) is projected onto the top side of the workpiece 15, which has a melting beam spot diameter. This is, for example, 1.5 mm or more, in particular from 3 mm to 25 mm. It can be seen that the laser beam 10 and the process gas jet 13 are perpendicularly incident on the workpiece 2 or the top side of the workpiece 15. This results in the material of the workpiece 2 melting along the depression-producing line 20, producing a melt which is blown off through the end hole 18 by means of the process gas jet 12. This produces the depression 19 along the depression-producing line 20 or around the first end hole edge 21. The depression 19 has a depression diameter d_{S} and has an outer depression edge 24 and an inner depression edge 25. The depression 19 opens into the top side of the workpiece 15 via the outer depression edge 24 (which is indicated in FIG. 2b, but not explicitly shown), whereas the depression 19 opens into the end hole 18 via its inner depression edge 25. The depression 19 forms, for example, a receiving space for a head portion of a fastener, such as a screw, a rivet, etc. FIG. 3a shows that the depression 19 has a frustoconical shape. A depression angle α, which is enclosed by a longitudinal center axis 26 of the depression hole 17 and an inclined depression chamfer 27 of the depression 19, is, for example, 32.5° in order to accommodate rivet heads, 41° in order to accommodate countersunk head screws designed according to US standards, 45° in order to accommodate metric countersunk head screws, 60° in order to accommodate sheet metal rivet heads, etc. The depression angle α can also be provided with other angle values depending on the application or requirements.

The end hole 18 can be produced in several stages, for example by forming a pilot hole 28 as the first end hole production stage (see, for example, FIGS. 4a/4b), but not finally producing the end hole 18 or the end hole diameter d_{E} in the first end hole production stage. In a second end hole production stage, the pilot hole 28 is then developed into the end hole 18. The first and second end hole production stages can be carried out directly one after the other. Alternatively, another method step, in particular the depression-producing laser process, can be carried out after the first end hole production stage and the second end hole production stage is only carried out after the other method step.

In FIG. 3b, the workpiece 2 is shown in a top view, wherein the depression hole 17 was produced by means of the punch-laser combination method or by means of the punch-laser combination machine 1.

Up to this point, a first variant of how the punch-laser combination method is used to produce the depression hole 17 has been described. In the first variant, the end hole is punched directly using the punching process, i.e., without first forming the pilot hole 28, and the depression 19 is then produced directly on the end hole 18 using the depression-producing laser process. Three further variants for producing the depression hole 17 by means of the punch-laser combination method or by means of the punch-laser combination machine 1 are explained below, wherein the pilot hole 28 is first formed in order to produce the end hole 18.

The pilot hole 28 has a pilot hole diameter d_{V} that is smaller than the end hole diameter d_{E}. The pilot hole 28 opens onto the top side of the workpiece 15 via a first pilot hole edge 29, and the pilot hole 28 opens onto the bottom side of the workpiece 16 via a second pilot hole edge 30. The pilot hole 28 is formed in such a way that it is aligned with the longitudinal center axis 26 of the depression hole 17 to be produced or that it defines the longitudinal center axis 26 of the depression hole 17 to be produced. The pilot hole edge 29, 30 and the end hole edge 21, 22, i.e., the radial plane cross-sections of the holes 18, 28, are geometrically similar to one another. Since the end hole 18 has a straight circular cylindrical shape in cross-section in the present case, the cross-sectional shape of the pilot hole 28 (see sectional views A-A in the corresponding figures) is represented as an appropriately straight circular cylinder. The base surfaces of the cross-sectional shapes, in this case base circle discs, of the radial plane cross-sectional shapes are geometrically similar to one another. The other variants have in common that the depression 19 is formed by means of the depression-producing laser process before the end hole 18 is produced. In other words, the depression 19 is not applied to the end hole 18, but to the pilot hole 28, and after the depression 19 has been produced, the pilot hole 28 is further developed into the end hole 18. In this regard, a punching step of the punch-laser combination method is involved to produce the end hole 18 in each variant, including the first variant.

In a second variant of the punch-laser combination method, the pilot hole 28 is punched using a pilot hole punching step of the punching process, after which the depression 19 is produced using the depression-producing laser process. The end hole 18 is then finally produced and thereby also the depression hole 17, specifically using the end hole punching step of the punching process. In this regard, FIG. 4 shows a schematic view cut along a sectional plane A-A (FIG. 4a) and top view (FIG. 4b) of the workpiece 2, wherein the pilot hole 28 is produced by means of a pilot hole punching step of the punching process. For this purpose, a punch variant 14b of the punch 14 is used, which corresponds in shape and size, in particular with the pilot hole diameter d_{V}, to the pilot hole 28 to be formed. The punch 14 is then moved towards the original workpiece 2, in particular towards the top side of the workpiece 15, specifically along the punching direction S. As the punch 14 is driven through the workpiece 2, a pilot hole punching slug (not shown) is driven out of the workpiece 2 so that a material-free space characterizing the pilot hole 28 passes through the workpiece 2. In FIG. 4a, the workpiece 2, which already has the pilot hole 28, is shown below the punch 14.

The depression-producing line 20 associated with the end hole 18 to be produced is then specified, along which the depression 19 is produced in the depression-producing laser process. If not already done at this stage of the method, the laser beam head 7 is switched to the melting mode for this purpose. In order to produce the depression 19, the laser beam 10 is guided over the top side of the workpiece 15 for material melting with a material melting linear energy, specifically once or multiple times along the depression-producing line 20.

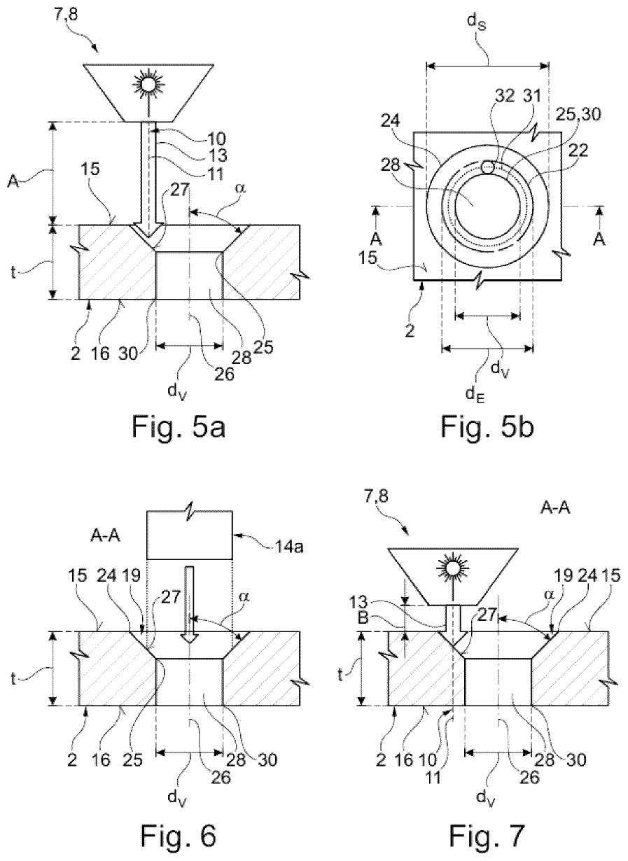

In this context, FIG. 5a shows a schematic view cut along the sectional plane A-A of the workpiece 2, wherein the depression 19 is produced at the pilot hole 28 by means of the depression-producing laser process. It can be seen that the laser beam head 7 is switched to the melting mode by adjusting the working distance to the melting working distance A. Along the depression-producing line 20, the material of the workpiece 2 is melted, producing the melt, which is blown off through the pilot hole 28 by means of the process gas jet 12. This produces the depression 19 along the depression-producing line 20 or around the first pilot hole edge 29. The depression 19 opens into the top side of the workpiece 15 via the outer depression edge 24 (which is indicated in FIG. 4b, but not explicitly shown), whereas the depression 19 opens into the pilot hole 28 via its inner depression edge 25.

FIG. 5b shows a top view of the workpiece 2, wherein the depression 19 and the pilot hole 28 have been formed, but the end hole 18 has not yet been produced. In this respect, according to FIG. 5b or at this stage of the method, the depression hole 17 is not yet finished; the pilot hole and depression arrangement shown in FIG. 5b is an intermediate product.

FIG. 6 shows a schematic view cut along the sectional plane A-A of the workpiece 2, wherein in the second variant the end hole 18 is finally produced by means of an end hole punching step of the punch-laser combination method, in particular the punching process. The end hole punching step is carried out after the pilot hole 28 and the depression 19 have been produced. The end hole punching step therefore takes place after the depression-producing laser process in time. In the end hole punching step, the punch variant 14a of the punch 14 corresponding to the end hole diameter d_{E} is used and moved towards the workpiece 2 having the pilot hole 28, in particular towards the depression chamfer 27, specifically along the punching direction S. As the punch 14 is driven through the workpiece 2, an end hole punching slug in the shape of a circular ring cylinder (not shown) is driven out of the workpiece 2, whereby the pilot hole 28 is further developed into the end hole 18. Reference is again made here to FIG. 3b, which shows the workpiece 2 in a top view, wherein the depression hole 17 was produced by means of the second variant of the punch-laser combination method or by means of the punch-laser combination machine 1.

In a third variant of the punch-laser combination method, the pilot hole 28 is punched using the pilot hole punching step of the punching process. After the pilot hole punching step, the depression 19 is produced using the depression-producing laser process. In this respect, reference is made to the above description. The end hole 18 is then finally produced using an end hole laser cutting process. FIG. 7 shows a schematic view cut along the sectional plane A-A of the workpiece 2, wherein the end hole 18 and thus the depression hole 17 are produced by means of the end hole laser cutting process. In order to carry out the end hole laser cutting process, the laser beam head 7 is switched to a cutting mode if the laser beam head 7 was switched to another operating mode, for example the melting mode, or deactivated before the end hole laser cutting process. In the end hole laser cutting process, i.e., for the final production of the end hole 18, the laser beam 10 is guided over the top side of the workpiece 15 for material cutting with a material cutting linear energy, specifically once or multiple times along an end hole-producing line 31 (see FIGS. 4b/5b). Here, the laser beam 10 can be formed as a pulsed laser beam. In order to switch or adjust the laser beam head 7 to the cutting mode, it is in particular intended that the laser beam head 7 is moved vertically (or along the Z direction, see FIG. 1) in order to adjust the working distance, over which the laser beam nozzle mouth 9 and the top side of the workpiece 15 are spaced apart from one another, to a cutting working distance B. A cutting beam spot 32 (see FIG. 5b) is thus projected onto the top side of the workpiece 15, in particular onto the depression chamfer 27. The cutting beam spot 32 has a cutting beam spot diameter. This is 0.1 mm to 0.5 mm, for example. The cutting working distance B is smaller than the melting working distance A, which means that the cutting beam spot diameter is smaller than the melting beam spot diameter. One result of this is that the material melting linear energy is lower than the material cutting linear energy. In order to switch the laser beam head between its modes, a laser beam energy or power of the laser beam 10 can be changed as an alternative or in addition to changing the working distance, an advance rate of the laser beam head 7 can be changed and/or the laser beam 10 can be focused/defocused by adjusting the laser optics, in particular using the optics adjustment actuator unit.

It can be seen that the laser beam 10 and the process gas jet 13 are perpendicularly incident on the workpiece 2 or the top side of the workpiece 15 or the depression chamfer 27. This forms a kerf along the end hole-producing line 31 that passes through the workpiece 2 completely. Thus, the end hole 18 is produced along the end hole-producing line 31 or around the second pilot hole edge 30, wherein the depression hole 17 is produced at the same time. The laser beam nozzle 8 or the laser tool 4 can be controlled in such a way that the laser beam nozzle mouth 9 dips into the depression 19 when cutting the end hole 18. Due to the laser beam nozzle mouth 9 dipping into the depression 19 in this manner, it is moved below a plane defined by the top side of the workpiece facing the laser tool 4 during the production of the end hole 18 or the depression hole 17. The workpiece 2, in which the depression hole 17 was produced by means of the third variant of the punch-laser combination method or by means of the punch-laser combination machine 1, is shown in a top view in FIG. 3b.

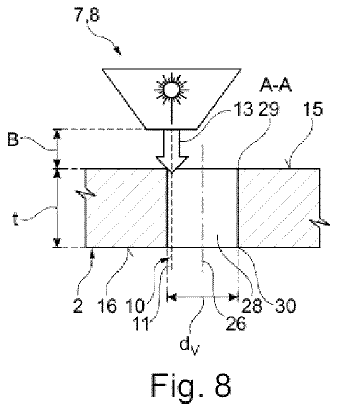

In a fourth variant of the punch-laser combination method, the pilot hole 28 is produced or cut by means of a pilot hole laser cutting process. After the pilot hole laser cutting process, the depression 19 is produced using the depression-producing laser process. The end hole 18 is then finally produced using the end hole laser cutting process. The depression-producing laser process and the end hole laser cutting process are set out in the above description. For the pilot hole laser cutting process, FIG. 8 shows a schematic view cut along the sectional plane A-A of the workpiece 2, wherein the pilot hole 28 is produced by means of the pilot hole laser cutting process. In order to carry out the pilot hole laser cutting process, the laser beam head 7 is switched to the cutting mode if the laser beam head 7 was switched to another operating mode, for example the melting mode, or deactivated before the pilot hole laser cutting process. In the pilot hole laser cutting process, i.e., to produce the pilot hole 28, the laser beam 10 is guided over the top side of the workpiece 15 for material cutting with the material cutting linear energy, specifically once or multiple times along a pilot hole-producing line (not shown). In particular, the working distance is adjusted to the cutting working distance B so that the cutting beam spot 32 (see FIG. 5b) is projected onto the top side of the workpiece 15. It can be seen that the laser beam 10 and the process gas jet 13 are perpendicularly incident on the top side of the workpiece 15, forming a kerf along the pilot hole-producing line that passes through the workpiece 2 completely. In this way, the material of the workpiece 2 is cut along the pilot hole-producing line and the pilot hole 28 is produced. The laser beam 10 can be generated here as a continuous wave laser beam. FIG. 3b shows the workpiece 2 in a top view, wherein the depression hole 17 was produced by means of the fourth variant of the punch-laser combination method.

Before the pilot hole laser cutting process, a dividing laser process is carried out in the present example to divide a pilot hole slug (not shown) to be cut out of the workpiece 2 in order to produce the pilot hole 28. In the dividing laser process, the laser beam head 7 is operated in the cutting mode.

The method and the punch-laser combination machine 1 demonstrate a way in which the depression hole 17 can be produced particularly efficiently and with a high degree of precision, low tolerances and high quality.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

t Workpiece thickness
d_{E} End hole diameter
d_{S} Depression diameter
d_{V} Pilot hole diameter
A Melting working distance
S Punching direction
α Depression angle
1 Punch-laser combination machine
2 Workpiece
3 Control device
4 Laser tool
5 Punching tool
6 Workspace
7 Laser beam head
8 Laser beam nozzle
9 Laser beam nozzle mouth
10 Laser beam
11 Beam symmetry axis
12 Focus/focal point
13 Process gas jet
14 Punch
14a Punch variant
14b Punch variant
15 Top side of workpiece
16 Bottom side of workpiece
17 Depression hole
18 End hole
19 Depression
20 Depression-producing line
21 First end hole edge
22 Second end hole edge
23 Melting beam spot
24 Outer depression edge
25 Inner depression edge
26 Longitudinal center axis
27 Depression chamfer
28 Pilot hole
29 First pilot hole edge
30 Second pilot hole edge
31 End hole-producing line
32 Cutting beam spot

1. A method for machining a workpiece, the method comprising:
providing a laser beam head, wherein the laser beam head is capable of being switched between a cutting mode and a melting mode, wherein in the cutting mode, a laser beam for material cutting with a material cutting linear energy is guided over a workpiece surface of the workpiece facing the laser beam head, and wherein in the melting mode, the laser beam for material melting with a material melting linear energy is guided over the workpiece surface,
forming an end hole which passes through the workpiece using the laser beam in a punching process,
specifying a depression-producing line associated with the end hole, and
forming a depression which opens into the end hole using the laser beam in a depression-producing laser process along the depression-producing line, wherein the laser beam head is operated in the melting mode in the depression-producing laser process.

2. The method according to claim 1, wherein forming the end hole comprises forming a pilot hole which passes through the workpiece, wherein the pilot hole is smaller than the end hole, and wherein an end hole edge of the end hole and a pilot hole edge of the pilot hole are geometrically similar.

3. The method according to claim 2, wherein the punching process comprises a pilot hole punching carried out before the depression-producing laser process, wherein the pilot hole is punched free in the pilot hole punching.

4. The method according to claim 2, wherein the pilot hole is cut free by a pilot hole laser cutting process carried out before the depression-producing laser process, wherein the laser beam head is operated in the cutting mode in the pilot hole laser cutting process.

5. The method according to claim 4, wherein a pilot hole slug to be cut out of the workpiece in order to produce the pilot hole is divided by a dividing laser process before the pilot hole is cut free, wherein the laser beam head is operated in the cutting mode in the dividing laser process.

6. The method according to claim 3, wherein the punching process comprises an end hole punching carried out after the depression-producing laser process, wherein the end hole is punched free in the end hole punching.

7. The method according to claim 2, wherein the end hole is cut free by an end hole laser cutting process carried out after the depression-producing laser process, wherein the laser beam head is operated in the cutting mode in the end hole laser cutting process.

8. The method according to claim 7, wherein, in the end hole laser cutting process, a laser beam nozzle mouth of a laser beam nozzle, from which the laser beam emerges, is moved within the depression and below a plane defined by the workpiece surface facing the laser beam head.

9. The method according to claim 1, wherein the depression-producing line is specified to be circular.

10. The method according to claim 1, wherein the depression-producing line is specified to be spiral-shaped.

11. The method according to claim 1, wherein a depression-producing line set comprising two or more depression-producing lines is specified, wherein the depression-producing lines of the depression-producing line set are geometrically similar to one another and share a common longitudinal axis.

12. A punch-laser combination machine configured to carry out the method according to claim 1.

13. A non-transitory computer-readable medium having a computer program stored thereon, the computer program, when executed by a control device for a punch-laser combination machine, causing the control device to carry out a method according to claim 1.
